(19) United States
(12) Patent Application Publication
(10) Pub. No.: US 2009/0019659 A1
(43) Pub. Date: Jan. 22, 2009

(54) SYSTEM

(76) Inventors: David Graham Hill, South Wales (GB); Sara Jane Hill, South Wales (GB)

Correspondence Address: INTELLECTUAL PROPERTY / TECHNOLOGY LAW, PO BOX 14329, RESEARCH TRIANGLE PARK, NC, 27709, US

(21) Appl. No.: 12/162,931

(22) PCT Filed: Feb. 5, 2007
(86) PCT No.: PCT/GB2007/000374

§ 371 Date: Oct. 2, 2008

(30) Foreign Application Priority Data
Feb. 4, 2006 (GB) 0602276.8

(51) Int. Cl. B44D 3/12; B05C 21/00; B65D 25/00

(52) U.S. Cl. 15/257.06; 220/570; 220/694; 220/736

(57) ABSTRACT

The invention in one aspect relates to a decorating system which includes at least a decorating medium receptacle for use in an upright position with a roller-type applicator, in which the receptacle has a container which receives decorating medium, and a removable or integral rolling platform positioned within the receptacle and. forming a roller-type applicator support means. The system may also comprise a decorating medium storage vessel and/or a decorating implement holder. The invention provides an easy to use decorating system when painting, wallpapering and/or performing other decorating tasks.

The present invention relates to decorating equipment such as roller paint trays, paint container holders and decorating utensil holders for use in painting, wallpapering and the other decorating tasks.

Roller paint trays are used for applying paint to a surface using a paint roller. A typical roller paint tray is an open pan-like structure with an inclined bottom surface that inclines at one end to form a shallow basin which is filled with a small amount of paint. The roller is rolled over the other end of the bottom surface to remove excessive paint prior to applying the paint to surface. The user may be required to fill the paint basin repeatedly in order to paint an area of surface such as four walls of a room.

Modifications of such roller paint trays for use in a horizontal position include those described in U.S. Pat. No. 3,091,793 which teaches a paint container with an insertable corrugated or screen tray to which a roller can be applied, and two handles which can be moved to the sides of the container to allow easier access to paint in the container. U.S. Pat. No. 3,602,939 teaches a paint container which can be used to store a quantity of paint and for the applying of the paint with a roller or pad applicator when the container is in a horizontal position. The container includes a paint regulator (or tray) extending from a side wall. U.S. Pat. No. 3,100,313 describes a paint roller platform which can be clipped into a standard horizontal roller paint tray to provide an additional means of removing excess paint from a roller.

The typical roller paint tray used in a horizontal position is, however, notoriously difficult to balance when filled with paint, requiring two hands to move the tray and avoid spillage. When painting from a ladder, the roller paint tray must be carefully carried horizontally to a step or rung of a ladder, where it can be balanced somewhat precariously.

Attempts to provide alternative roller paint trays or accessories for roller paint trays have been made. For example, U.S. Pat. No. 6,341,666 discloses an accessory tray which fits onto a stepladder, allowing a roller paint tray of the standard type to be more stably positioned in a horizontal position. Meanwhile, U.S. Pat. No. 5,842,253 teaches a ladder-supported holding tray which includes a paint receptacle and which can be releasably attached to a step ladder. U.S. Pat. No. 3,351,970 discloses a roller paint tray with a detachable drain board, in which the tray comprises an enclosed paint which allows the tray to be used in a vertical position with a roller-type applicator. The tray also comprises a pair of hook shaped members adjacent the rear upper portion thereof, into which straps can be fitted to allow the tray to be carried on a person. US2002/0005409 describes a roller paint tray which can be used in a vertical or horizontal position and similarly comprises an enclosed paint basin as well as a pair of hooks attached to one end that allows the paint tray to rest vertically on the rung(s) of a ladder. Using a partially enclosed paint basin to allow the roller paint tray to be used in a vertical position has also been described for example in US2002/0100848, US2002/0112309, CA1221057, GB2363677 and US2005/0217059.

In another modification, U.S. Pat. No. 2,827,648 describes a roller paint platform which can be inserted into a paint container. WO2004/101170 in turn describes a paint roller tray which has two flexible arms allowing the tray to be coupled to a paint tin, such that the roller tray can be maintained in a vertical position allowing excess paint to flow back into the paint tin. U.S. Pat. No. 5,123,576 describes a paint can accessory which includes a tray with vertical sides and a large opening defined by a downwardly directed, tapered cylinder that seals into the top of a paint can. Supports are positioned on the tray to hold a paint brush on its edge and a paint roller, although the tray is also designed for use as a roller tray. A combined scraping plate and roller screen is fixed across the opening of the tray.

A paint container with a main body having first cavity for holding paint and a second cavity for holding paint brushes is described in GB2231550 and US2004/0195248. In US2004/0195248, the two cavities are separated by a divider which can be used a roller surface. The container is attachable to the top of a stepladder via a handle integral with the main body which is insertable into a hole in the top step of a ladder.

WO03/004288 describes a paint utensil holder which can be secured to a roller paint tray. The holder has an elongated platform formed as an open framework to allow excess paint from a paint roller positioned on the platform to drain into the paint reservoir of the paint tray.

U.S. Pat. No. 5,489,051 teaches an apparatus for carrying paint and paint application related tools suspended on the hip of a painter using a hip-supported, belt-attached base member which is attached by means of a separable ball and socket joint to a freely swinging sealable paint container and fitted tool carrier.

Although various roller paint trays and accessories have been described in the prior art, there remains the need for a usable alternative from the standard horizontal paint roller tray which is still widely used despite its limitations. The present invention provides a decorating system which is easy to use when painting, wallpapering and/or performing other decorating tasks, and which address the practical and/or economical disadvantages associated with prior art systems.

According to a first aspect of the invention, there is provided a decorating system comprising one or two or all of the following:

(a) a decorating medium receptacle for use in an upright (i.e. generally vertical) position with a roller-type applicator, in which the receptacle has walls extending upwardly from a base forming a container which receives decorating medium, and a removable or integral rolling platform positioned within the receptacle at an angle to a wall, for example a back wall, with a distal part of the platform located towards the base of the receptacle and forming a roller-type applicator support means; and/or
(b) a decorating medium storage vessel; and/or
(c) a decorating implement holder.

The decorating system in another aspect comprises the decorating medium receptacle and optionally also comprises the decorating medium storage vessel and/or the decorating implement holder.

The decorating medium receptacle of the system has an advantage over the standard paint roller tray because it can be used in an upright (i.e. generally vertical) position.

However, the receptacle also includes a roller-type applicator support means at the distal part of the platform which means that a roller-type applicator can be left in the receptacle, in an upright position, when not in use, without the need for a restraining clip. The roller-type applicator is held more stably than within the receptacle in comparison with prior art paint roller trays such as that in U.S. Pat. No. 3,351,970 where a notch in a top wall of the tray provides a rest for a roller handle which could be knocked out of place easily during use or transportation of the tray.

In one aspect, the decorating medium receptacle container which receives decorating medium excludes a cylindrical tin or can (although as described below, in another aspect of the invention the decorating medium storage vessel may be adapted to receive a can or tin).

The distal part of the platform forming the roller-type applicator support means may be located above the maximum level where decorating medium would typically be received in the receptacle. This would allow the roller-type applicator to be left in the receptacle clear from the decorating medium.

The distal part of the platform may be curved to form the roller-type applicator support means. A curved shape conveniently provides a housing for supporting a generally cylindrical roller portion of a roller-type applicator.

The distal part of the platform may have a stop means to provide support to the roller-type applicator. The stop means may, for example, be tubular. In combination with a curved roller-type applicator support means, the tubular stop provides an additional means for keeping the roller-type applicator within the support means.

The distal part of the platform may have an aperture, for example one or more perforations or drain holes, to allow drainage of decorating medium from the platform and/or roller-type applicator into the container. Excess paint from the platform and/or the roller-type applicator will fall into the receptacle.

The platform may comprise a transverse rib to assist loading of decorating medium onto a roller-type applicator. Typically, the platform will comprise more than one transverse ribs. The ribs assist loading of decorating medium onto a roller-type applicator by allowing a user to regulate the amount of decorating medium left on the applicator.

As used herein, the term “roller-type applicator” encompasses a roller commonly used for application of paint or other decorating medium types. However, the invention may also be of use with other decorating medium applicators. For example, a paint pad may be regulated on the platform in a similar manner to a roller-type applicator. In one aspect of the invention, the term “roller-type applicator” encompasses the more general term “decorating medium applicator”. In another aspect of the invention, the term “roller-type applicator” excludes a paint pad.

The platform may be positioned within the receptacle at an angle from a wall, for example from the back wall, by a positioning means optionally integral with the platform. The angle may be from about 0° to about 60°, preferably about 10°. The positioning means may be part of the receptacle, and/or may be part of the platform. Rather than being inclined strictly vertically, it has been found that the platform is easier to use if positioned at an angle away from a wall.

When the platform is removable, it may have a locating means at its proximal end for attaching to a wall, for example the back wall. The locating means may be folds which sit over the wall, for example a relieved section of the wall.

The receptacle may further comprise a compartment for holding a decorating implement. The compartment may be in fluid communication with the receptacle, for example by means of a perforated or open base and/or a side-wall of the compartment. In one embodiment, the receptacle comprises a compartment located on each of two opposite side-walls of the receptacle. These compartments optionally drain into the receptacle by means of the perforated or open base.

A promixal end of a wall away from the base of the receptacle may comprise a scraping edge. In one aspect, there is a scraping edge at each of two side walls of the receptacle, allowing excess paint from a decorating implement such as paint brush to be removed in a left-handed or right-handed manner.

An upper rim of a wall or junction between two walls of the receptacle may comprise a pouring lip. The lip allows the receptacle to be emptied of decorating medium. The lip may for example be a cut-away section at a junction between a front and side wall of the receptacle.

The receptacle may comprise a securing means for securing a handle of the roller-type applicator when not in use. In one embodiment, the securing means may be hinged to a wall of the receptacle to allow the securing means to be moved into and/or away from a securing position. The securing means provides additional support for the roller-type applicator.

The receptacle may comprise a handle, for example a foldable or collapsible handle which can be folded or collapsed when not in use.

In a further aspect of the invention, a scraping edge may be located on the handle. For example, one or more sides of the handle may comprise a scraping edge. The scraping edge may be formed by a tapered section of the handle. The scraping edge will allow excess paint or other decorating medium from a decorating implement such as paint brush to removed. The scraping edge may be positioned such that excess paint or other decorating medium removed from the paint brush or other decorating implement falls into the receptacle.

The receptacle suitably is designed to hold a reasonable quantity of decorating medium. The base of the receptacle may have rounded edges and corners to facilitate loading of a roller-type applicator and to prevent decorating medium from becoming trapped. The surface of the base of the receptacle facing into the receptacle may be inclined at an angle so that decorating medium drains away from a rear wall towards a front wall where the decorating medium can be accessed by the roller-type applicator. Leveling feet may be positioned beneath the outer surface of the base to incline the base at an angle while ensuring that the receptacle is stable on a horizontal surface.

In a further aspect of the invention, the decorating medium storage vessel comprises an open end formed by an upper rim of side walls extending upwardly from a base, in which the vessel is suitable for holding a decorating medium and/or a decorating medium pot (which term includes “tin”).

The base of the vessel may be stepped to provide a snug fit with one of two or more differently-sized decorating medium pots, for example a 0.5 litre and a 1 litre paint tin or can.

The vessel may comprise a device, for example a scraper, which is positionable across the open end and which allows for removal of excess decorating medium from a decorating implement. This is preferably to using the upper rim of a decorating medium pot, for example a paint tin or can, for removing excess decorating medium because the device allows excess decorating medium to drain into the vessel rather than drip over the side of the pot.

The device preferably comprises a tapered edge. The device may also provide a resting surface for the decorating implement, which may be used in combination or independently from with a decorating support implement support structure mounted onto the upper rim.

The device may have an arm hinged to a side of the vessel to allow the device to be positioned across and/or to be raised from the open end of the vessel.

The vessel may have a handle, which may be collapsible or foldable when not in use.

In a further aspect of the invention, the decorating implement holder of the system comprises multiple compartments which accommodate decorating implements and optionally decorating medium. The decorating implements may, for example, include tools associated with wallpaper hanging.

The decorating implement holder may have a handle, which may be collapsible or foldable when not in use.

According to the invention, the system may additionally comprises a holding device onto which a mounting means located on the receptacle and/or the vessel and/or the decorating implement holder can be detachably mounted. The receptacle and/or the vessel and/or the decorating implement holder may be mounted sequentially or simultaneously to the holding device.

The holding device may, for example, comprise a holster which may be attachable to a belt, a ladder, steps, platform or shelf. Alternatively, the holding device may comprise part of a ladder, steps, platform or shelf.

The holding device may provide a storage means for the receptacle and/or the vessel and/or the decorating implement holder. For example, the holding device may be attachable to a surface such as a wall to allow the receptacle and/or the vessel and/or the decorating implement holder to be mounted and stored on the surface. The storage means allows the components of the system to be conveniently stored in an upright position.

The mounting means on the receptacle and/or the vessel and/or the decorating implement holder may comprise an attachment means for securing the receptacle and/or the vessel and/or the decorating implement holder to a complementary attachment means on the holding device. For example, the attachment means and its complement may comprise an opening through which an attachment key (or knob or button) on the holding device is insertable, or vice versa. Alternatively, the attachment means and its complement may be a dovetail attachment. The mounting means may suitably further comprise guide channels or grooves to guide the attachment means and its complement together. The mounting means may comprise or be part of a supporting plate integral with or attachable to the receptacle and/or the vessel and/or the decorating implement holder.

In one aspect, the mounting means and the complementary attachment means, when fitted together, do not allow free swinging movement (in contrast to that found in U.S. Pat. No. 5,489,051). Rather, there may be controllable movement and/or no movement between the mounting and attachment means.

Where the mounting means is a storage means, the mounting means may comprise complementary attachments means, for example mounting means such as the attachment key, optionally integral with or fixable to the supporting plate, securable to a surface such as a wall.

The receptacle and/or the vessel and/or the decorating implement holder and/or the holding device may comprise a locking stop means which prevents the attachment means from accidentally disengaging from the complementary attachment means on the holding device. In one example, the locking stop means may be single-handedly operable, such as a single-handedly operable sprung lock.

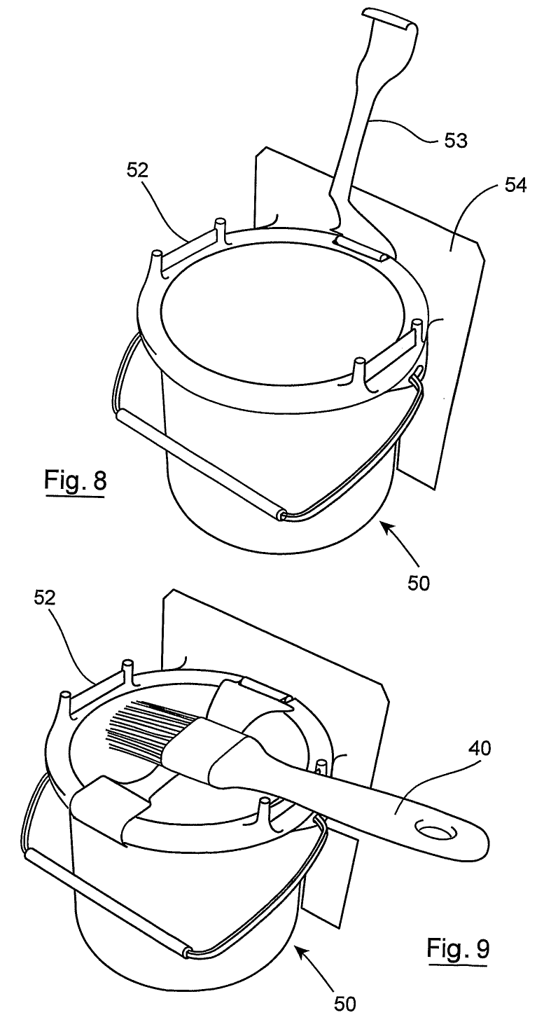

The rear upper lip of the receptacle may be slightly relieved to form a mounting rim for the platform (see FIGS. 7A and 7B). The rear upper lip of the receptacle may be fitted with a locking stop which, when fitted to the holding device, ensures that the receptacle cannot be accidentally knocked off the holding device whilst maneuvering.

When the receptacle and/or the vessel and/or the decorating implement holder is mounted onto the holding device, a user will be able to access their work with both hands or be able to more safely climb ladders or the like.

The decorating medium as described herein may be paint, glue, paste, varnish, cleaning fluid and/or stripper fluid.

The decorating implement as described herein may be a paint brush, an edge roller, a knife, a scraper, a paste brush, a paint pad, scissors, a pencil, and/or a tape measure.

The decorating medium receptacle as described herein may further include a removable and optionally hinged lid which when closed provides a substantially air-tight seal over the container. Similarly, the decorating medium storage vessel may comprise a removable and optionally hinged lid which when closed provides a substantially air-tight seal covering the open end. In another aspect of the invention, however, the decorating medium receptacle and/or the decorating medium storage vessel do not have a lid.

Further provided accorded the present invention is a decorating medium receptacle as defined herein, optionally in combination with the holding device.

Also provided accorded the present invention is a decorating medium storage vessel as defined herein, optionally in combination with the holding device.

According to another aspect of the invention there is provided a decorating medium storage vessel as defined herein, optionally in combination with the holding device.

According to another aspect of the invention there is provided a decorating implement holder as defined herein, optionally in combination with the holding device.

According to a further aspect of the invention there is provided a holding device as defined herein.

Each part of the system suitably may be moulded from a plastics material.

All references cited herein are incorporated by reference in their entirety.

Further features of the present invention will become apparent from the following non-limiting examples. Generally speaking the invention extends to any novel one, or any novel combination, of the features disclosed in this specification (including any accompanying claims and drawings). Moreover unless stated otherwise, any feature disclosed herein may be replaced by an alternative feature serving the same or a similar purpose.

The present invention will now be further described with reference to the following non-limiting examples and with reference to the accompanying illustrative drawings, in which:

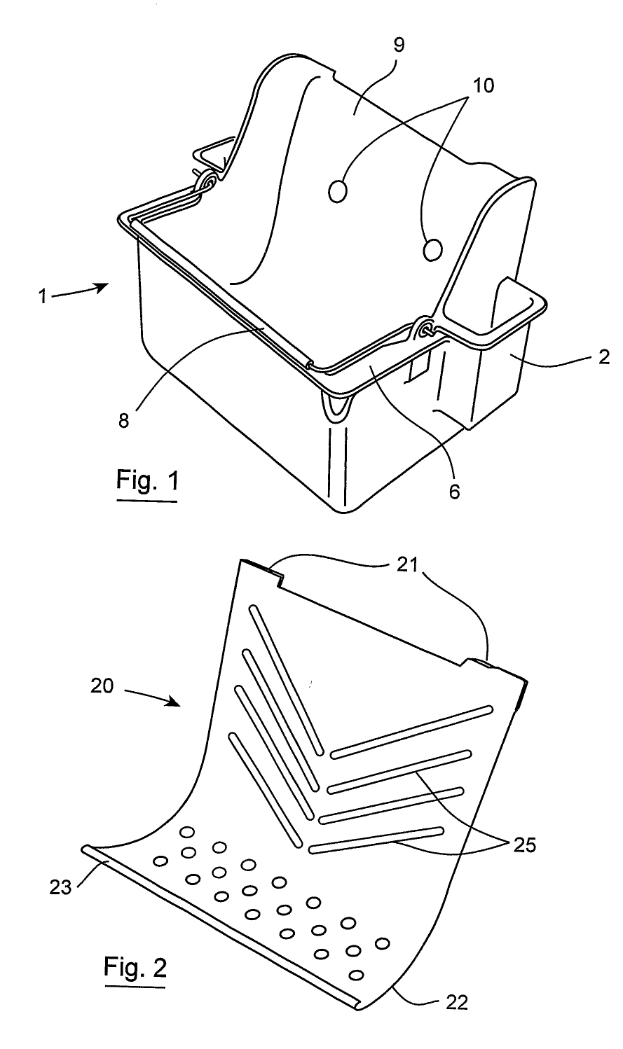

FIG. 1 is a perspective view of a first embodiment of a paint receptacle according to the invention;

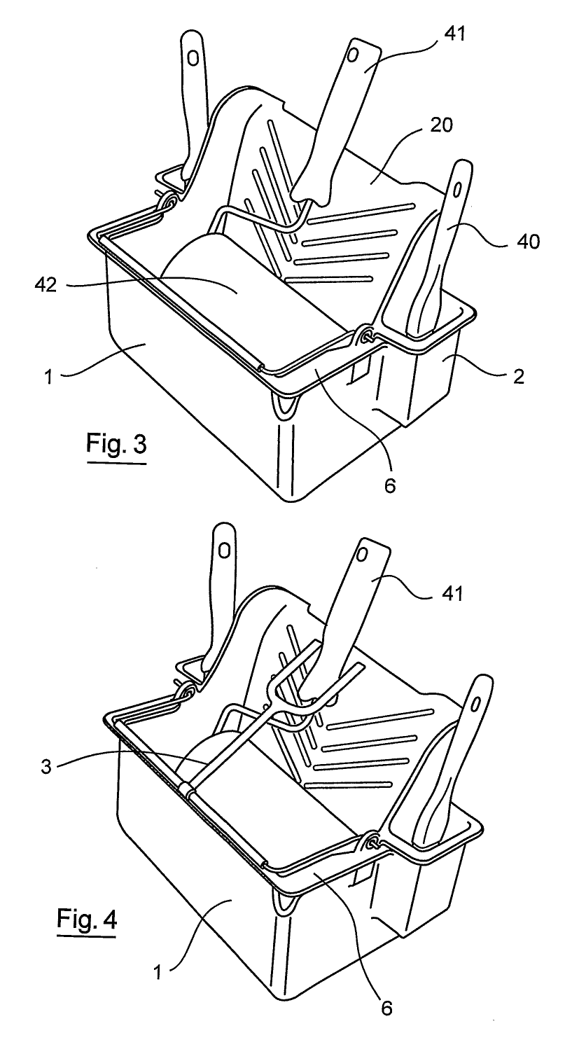

FIG. 2 is a perspective view of a rolling platform for use with the paint receptacle shown in FIG. 1;

FIG. 3 is a perspective view of the rolling platform of FIG. 2 positioned in the paint receptacle of FIG. 1;

FIG. 4 is a perspective view of the rolling platform of FIG. 2 positioned in the paint receptacle of FIG. 1 and showing a clip-on roller grip in place;

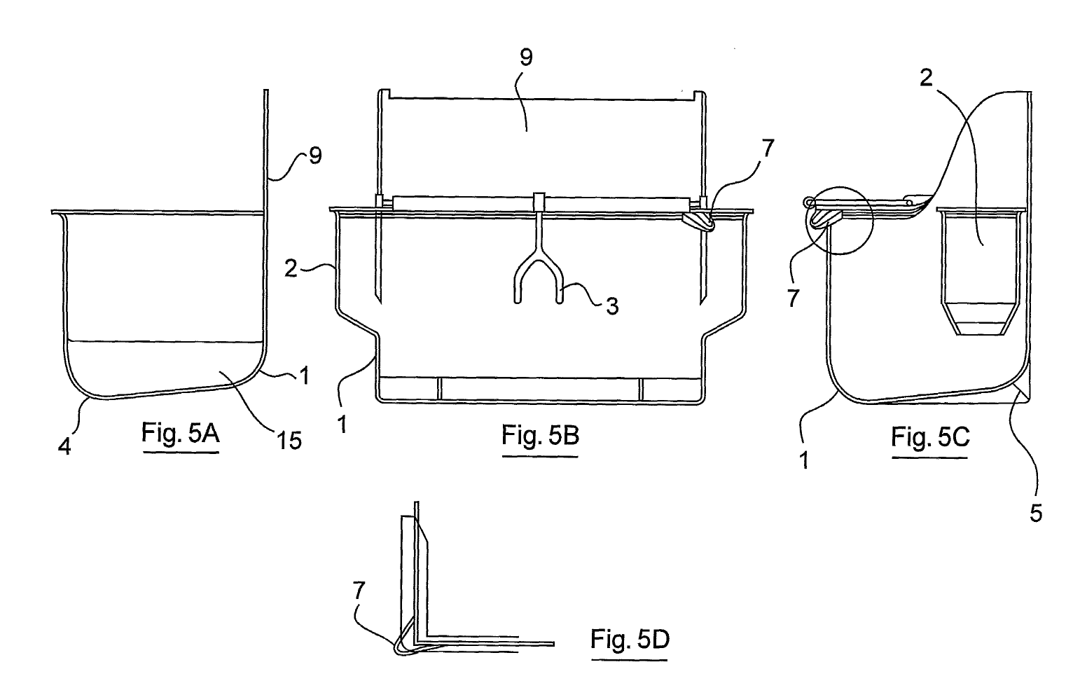

FIG. 5A is a side cross section, FIG. 5B a front view, and FIG. 5C a right end view of the paint receptacle as shown in FIG. 1, with FIG. 5D providing a detailed corner view of the area circled in FIG. 5C;

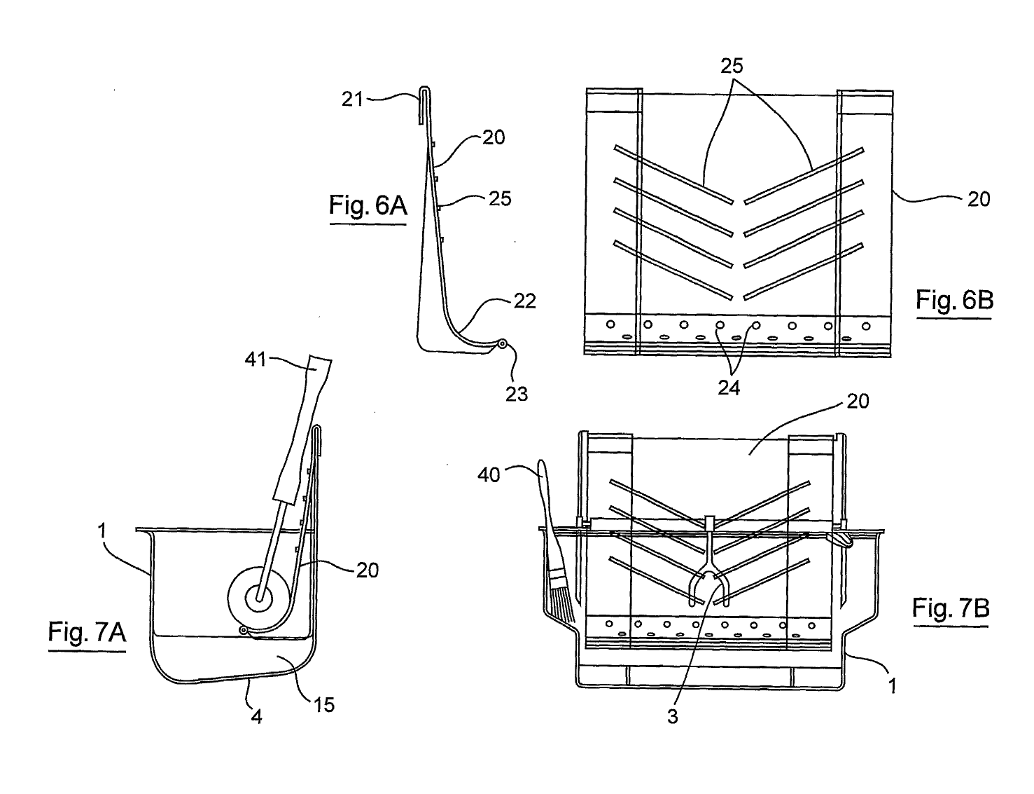

FIG. 6A is a side cross section and FIG. 6B a front view of the rolling platform of FIG. 2;

FIG. 7A is a side cross section of the platform of FIG. 2 positioned in the paint receptacle of FIG. 1 with a roller in place on the rolling platform, while FIG. 7B is a front view of the platform of FIG. 2 positioned in the paint receptacle of FIG. 1 with a paint brush in a side compartment of the receptacle;

FIG. 8 is a perspective view of a paint storage vessel according to the invention;

FIG. 9 is a perspective view of the paint storage vessel of FIG. 8 with a flip-over paint scrape device on which a paint brush is resting;

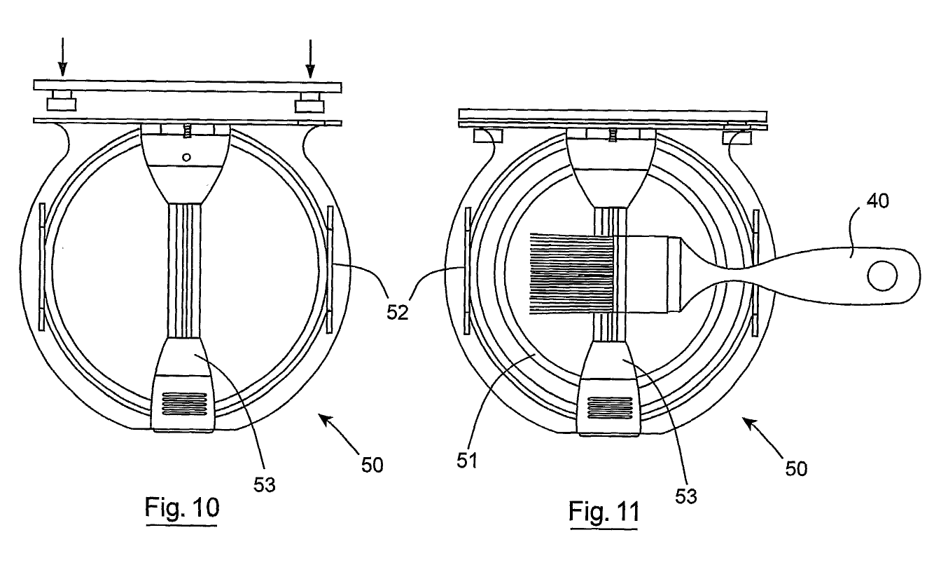

FIG. 10 is a top plan view of the paint storage vessel of FIG. 8;

FIG. 11 is a top plan view of the paint storage vessel of FIGS. 8 to 10, showing a paint pot immersed therein and with a paint brush resting on the flip-over paint scrape device;

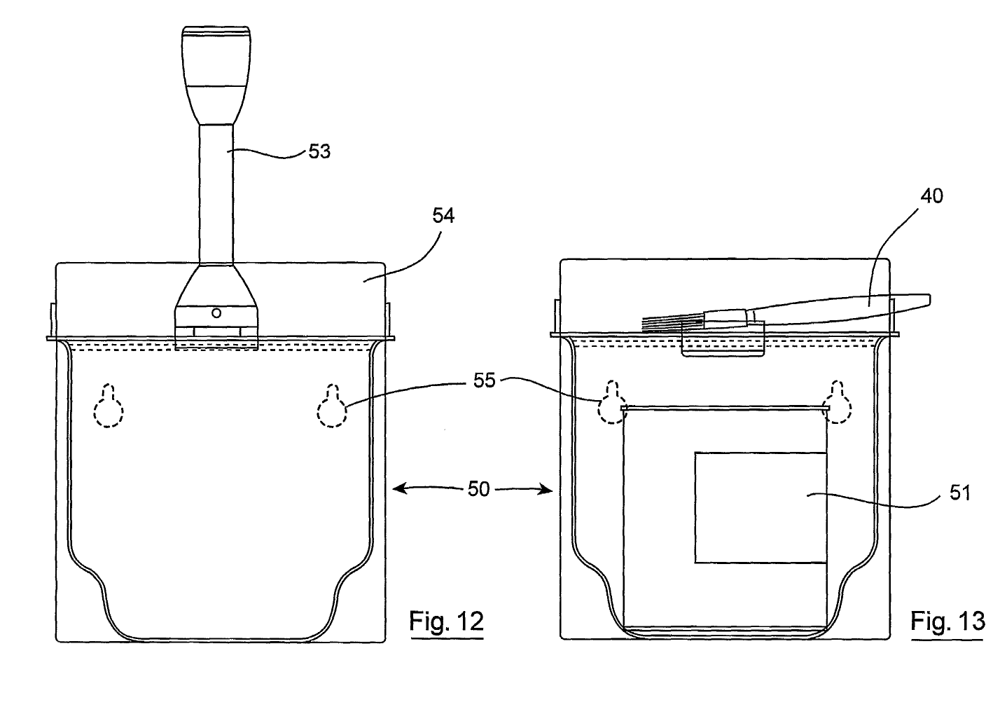

FIG. 12 is a front view of the paint storage vessel of FIGS. 8 to 11 with the flip-over paint scrape device in an open position;

FIG. 13 is a front view of the paint storage vessel of FIGS. 8 to 12 with the flip-over paint scrape device in a closed position, a paint brush resting on the device, and a paint tin immersed in the vessel;

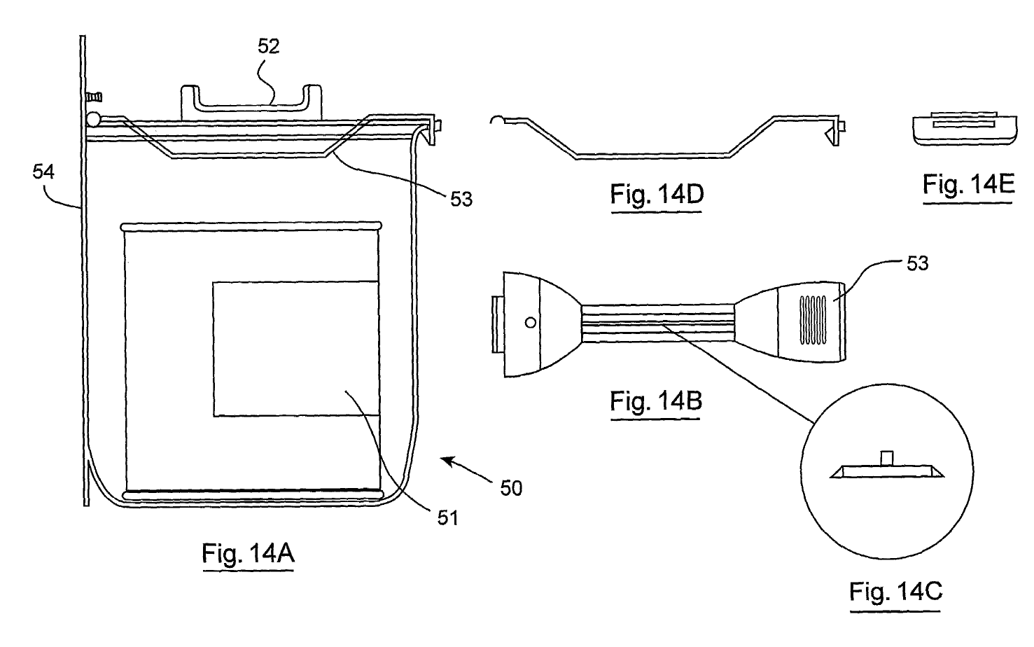

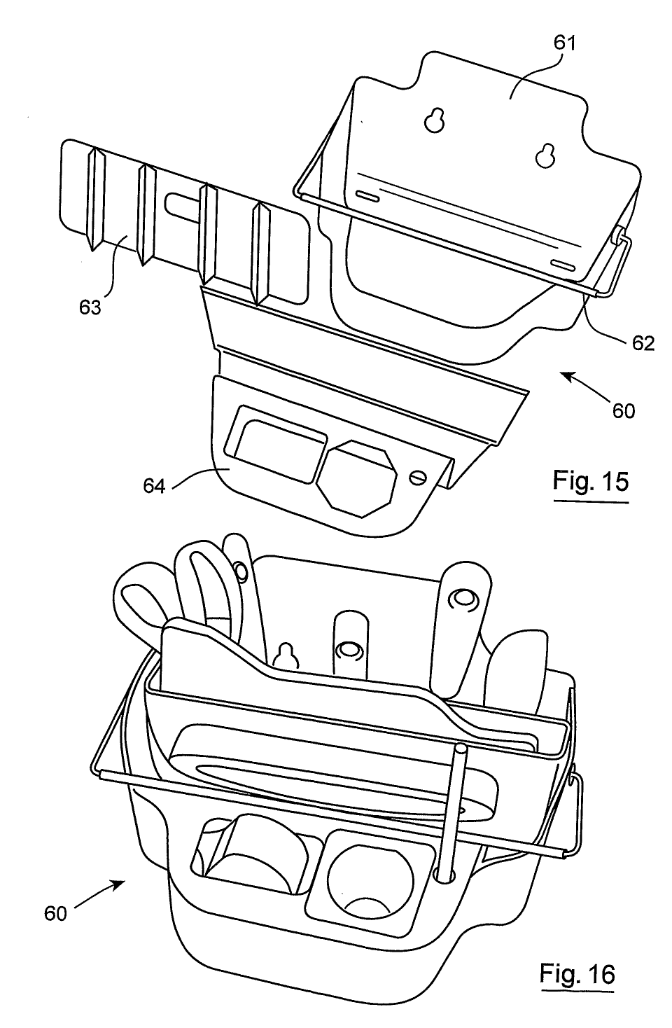

FIG. 14A is a side view of the paint storage vessel of FIGS. 8 to 13 with the flip-over paint scrape device in a closed position, a paint brush resting on the device, while FIGS. 14B to 14E are exploded views of various components of the vessel;

FIG. 15 is a perspective view of various parts of a wallpaper implement holder according to the invention;

FIG. 16 is a perspective view of the wallpaper implement holder of FIG. 15 in an assembled state and including various implements;

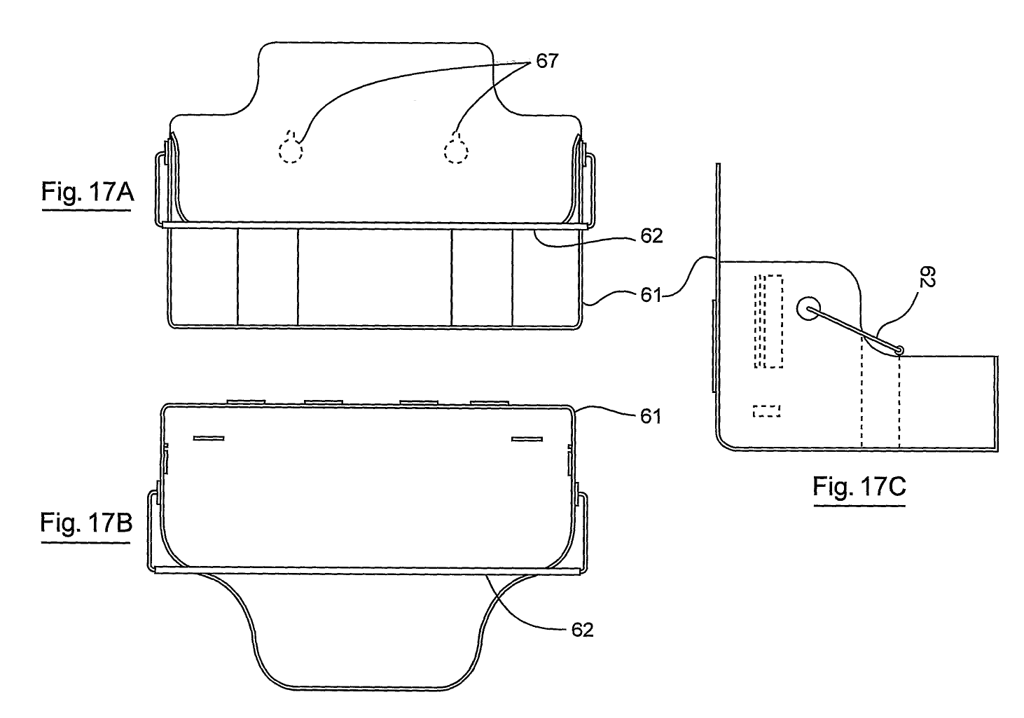

FIGS. 17A to 17C are front, top and side views of a main body part of the wallpaper implement holder of FIGS. 15 and 16, respectively;

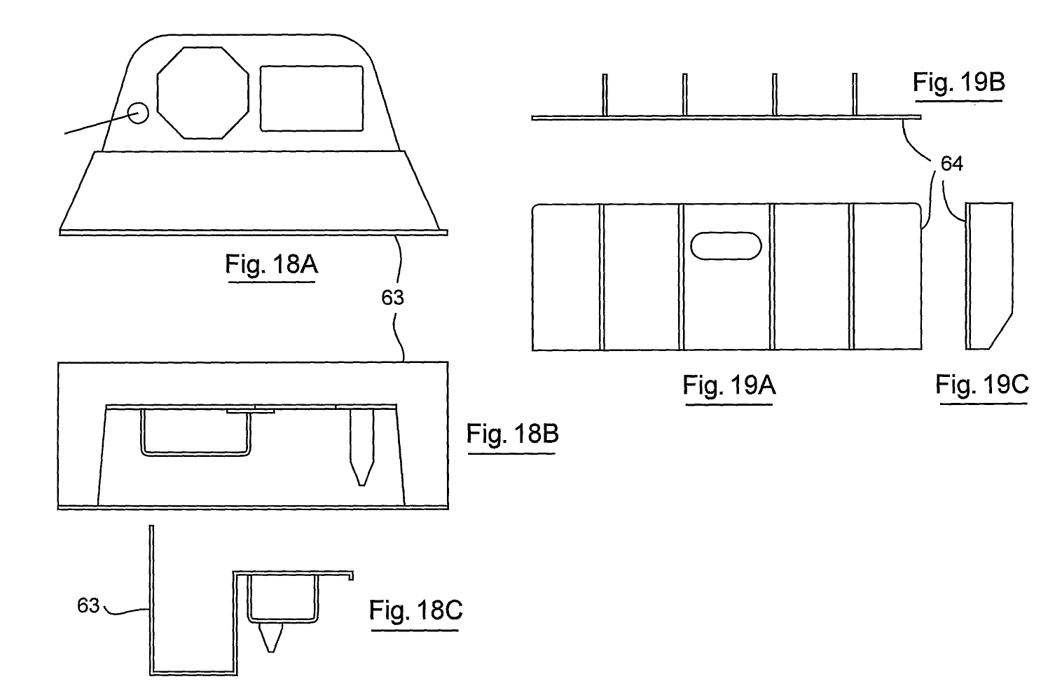

FIGS. 18A to 18C are top, front and cross-section views, respectively, of a first compartment part of the wallpaper implement holder of FIGS. 15 and 16;

FIGS. 19A to 19C are front, top and cross-section views, respectively, of a second compartment part of the wallpaper implement holder of FIGS. 15 and 16;

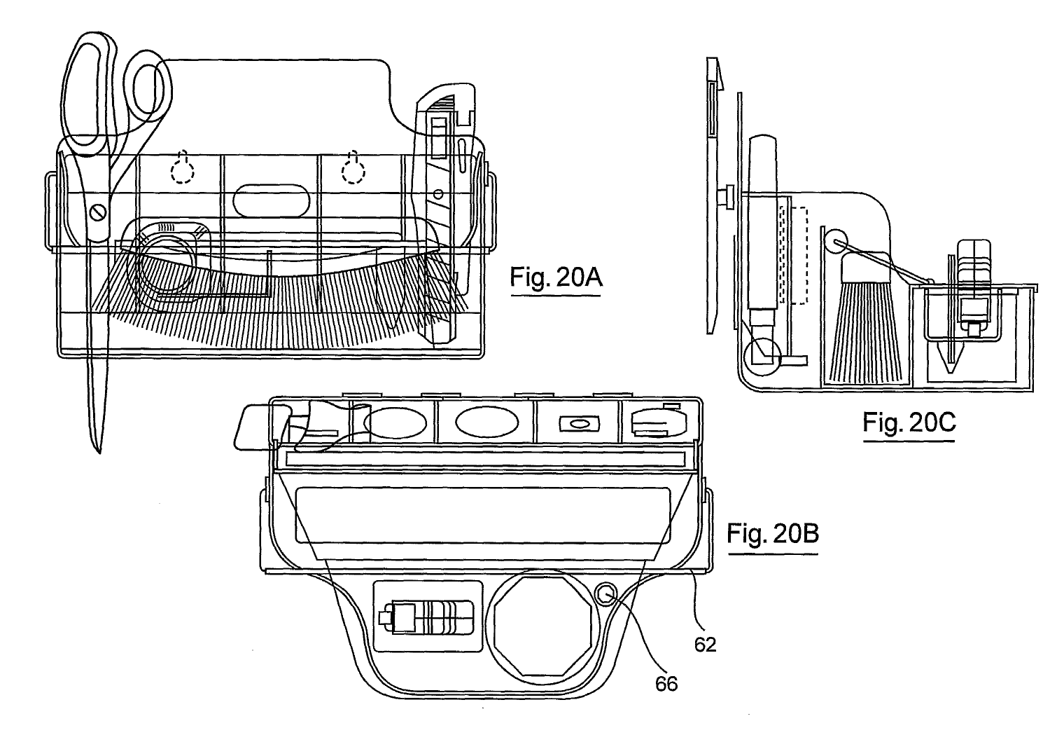

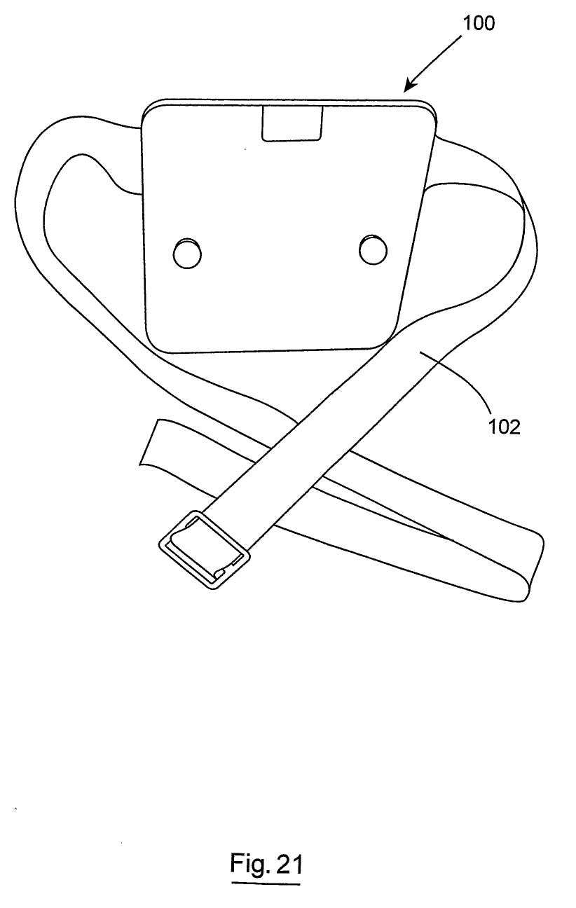

FIGS. 20A to 20C are front, top and cross-section views, respectively, of an assembled wallpaper implement holder of FIGS. 15 and 16, showing various implements;

FIG. 21 is a perspective of a first embodiment of a holding device according to the invention;

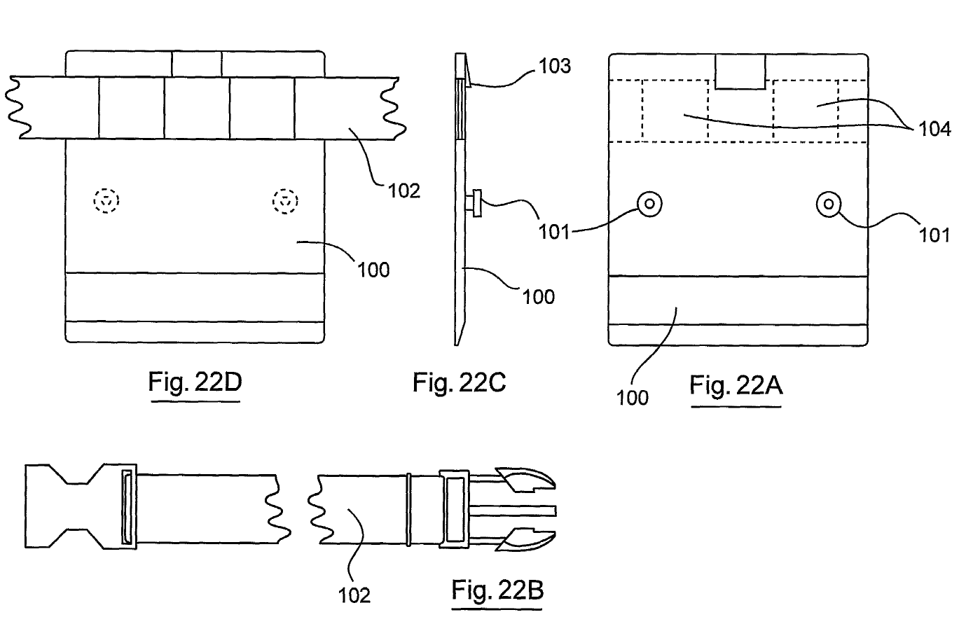

FIGS. 22A to 22D are various views of the holding device shown in FIG. 21, as explained below;

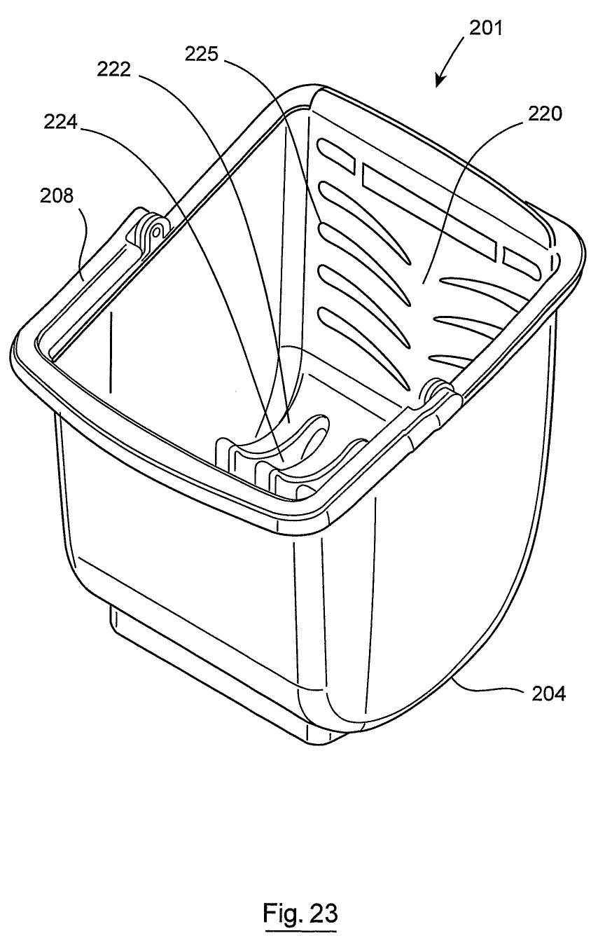

FIG. 23 is a corner view of a second embodiment of a paint receptacle according to the invention;

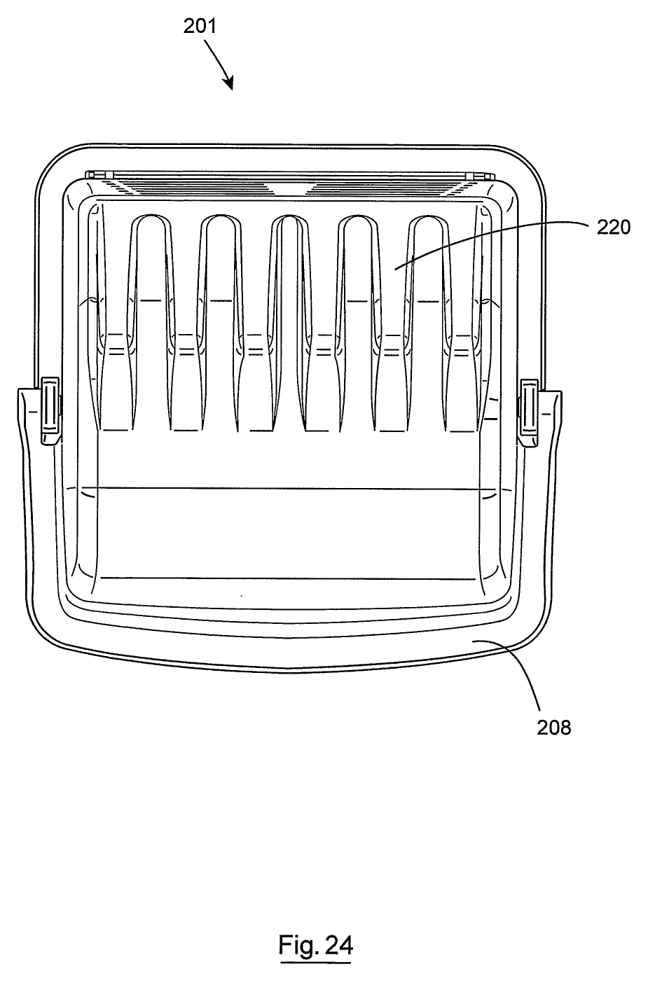

FIG. 24 is a plan view of the paint receptacle of FIG. 23;

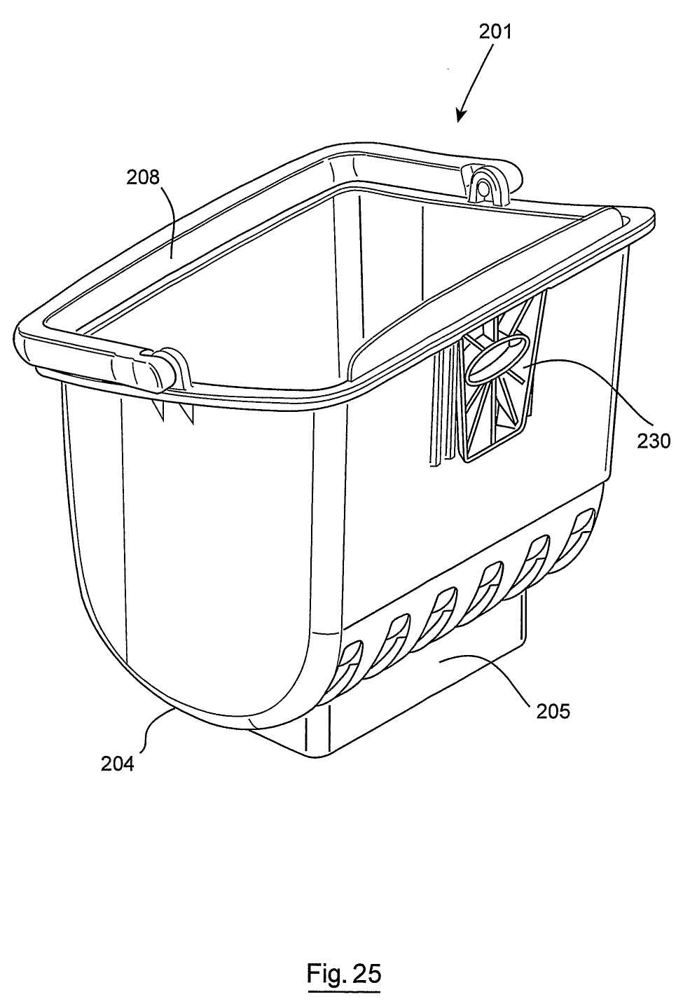

FIG. 25 is a rear view of the paint receptacle shown in FIGS. 23 and 24;

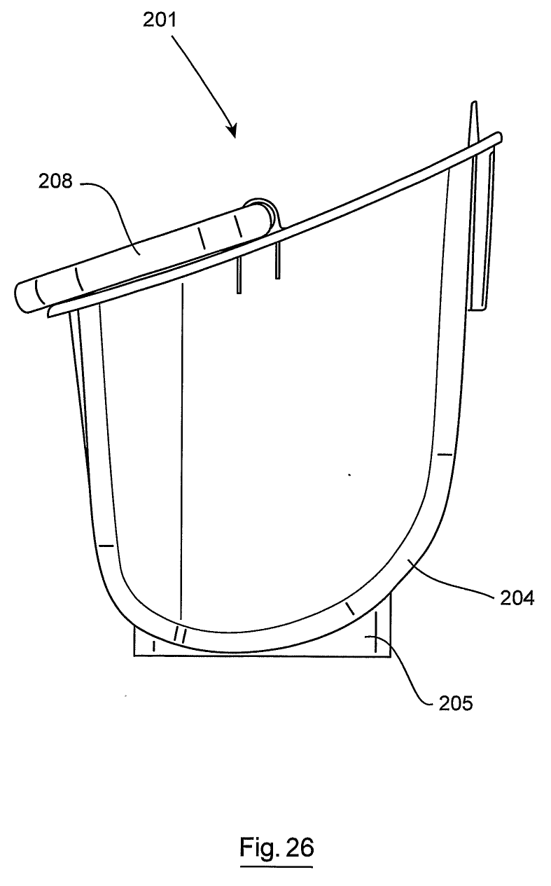

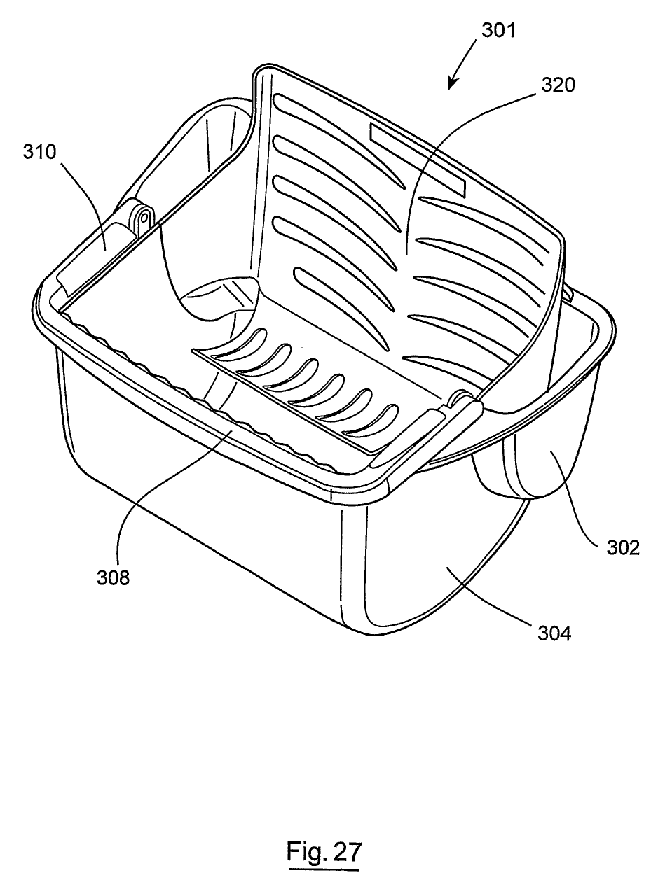

FIG. 26 is an end view of the paint receptacle shown in FIGS. 23-25;

FIG. 27 is a corner view of a third embodiment of a paint receptacle according to the invention;

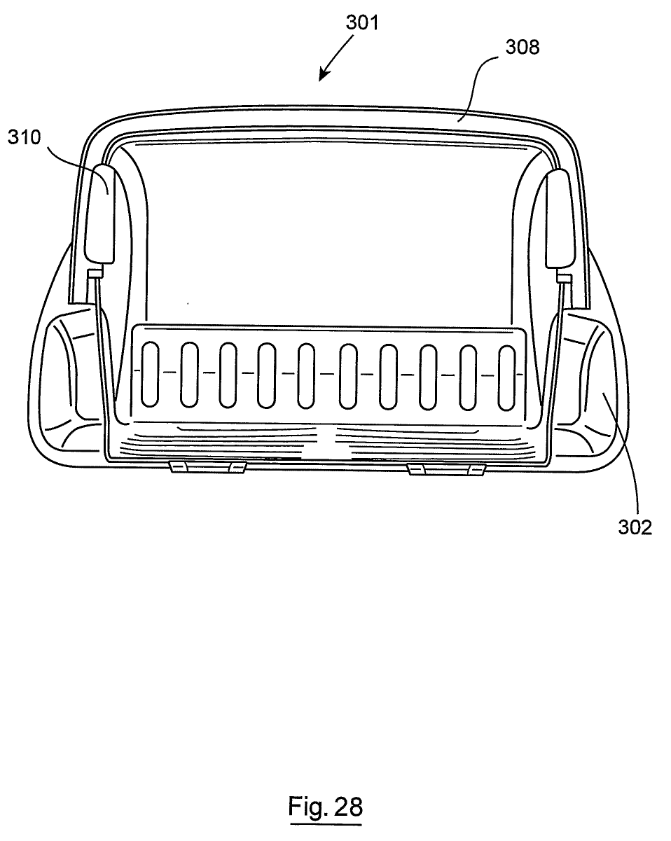

FIG. 28 is a plan view of the paint receptacle of FIG. 27;

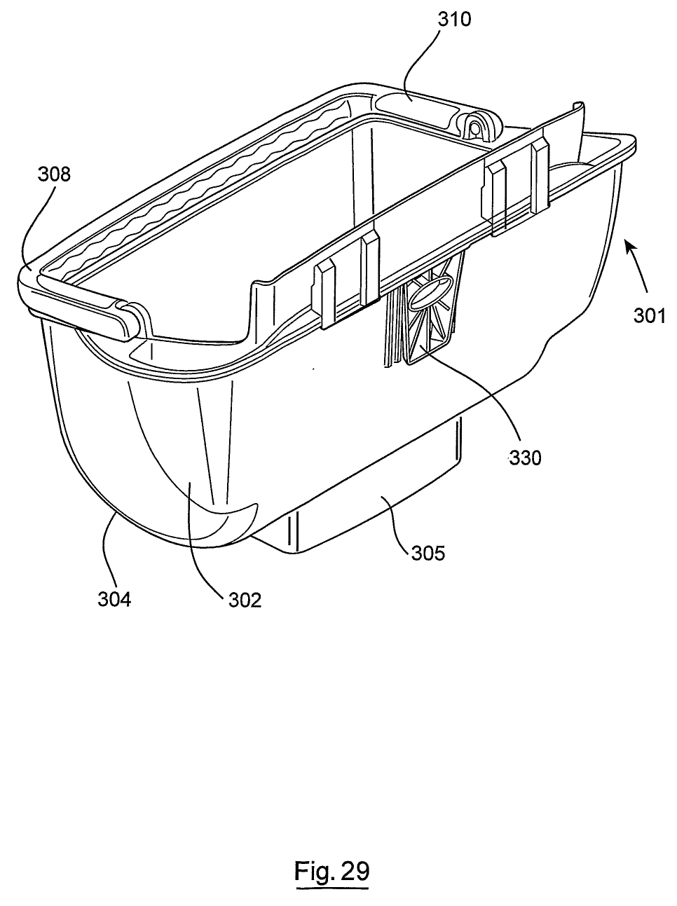

FIG. 29 is a rear view of the paint receptacle shown in FIGS. 27 and 28;

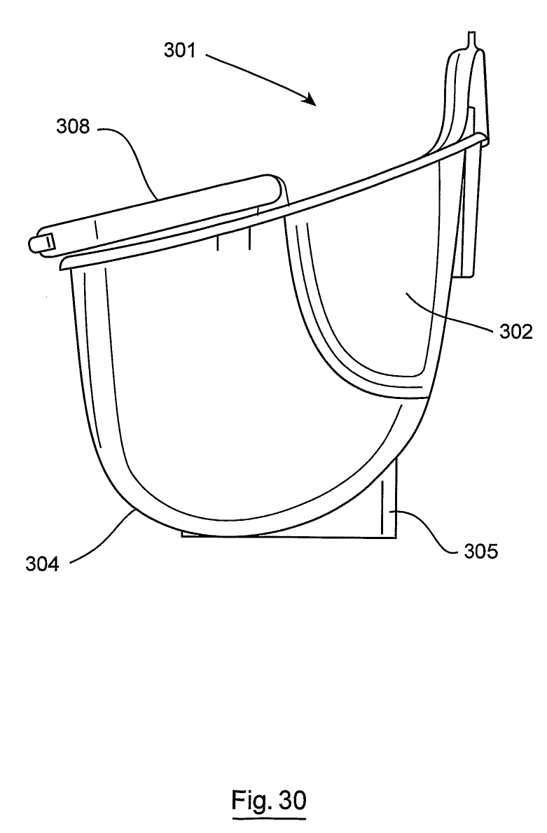

FIG. 30 is an end view of the paint receptacle shown in FIGS. 27-29;

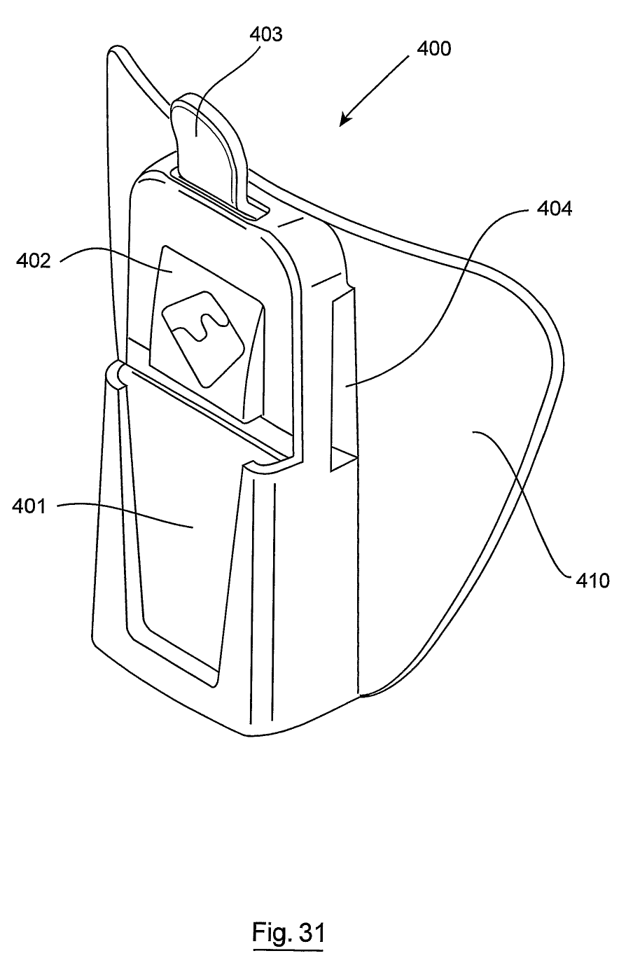

FIG. 31 is a corner view of a second embodiment of a holding device according to the invention;

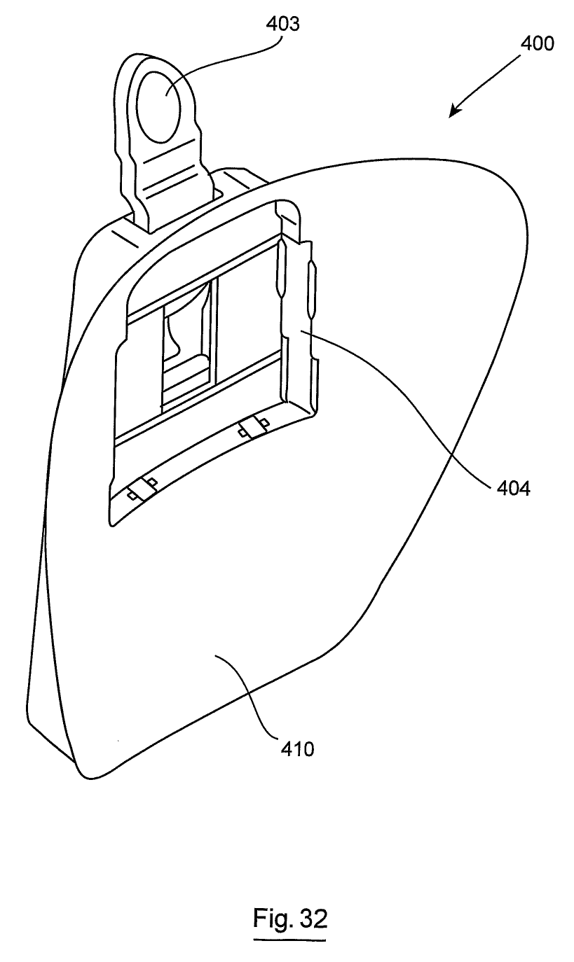

FIG. 32 is a rear view of the holding device shown in FIG. 31;

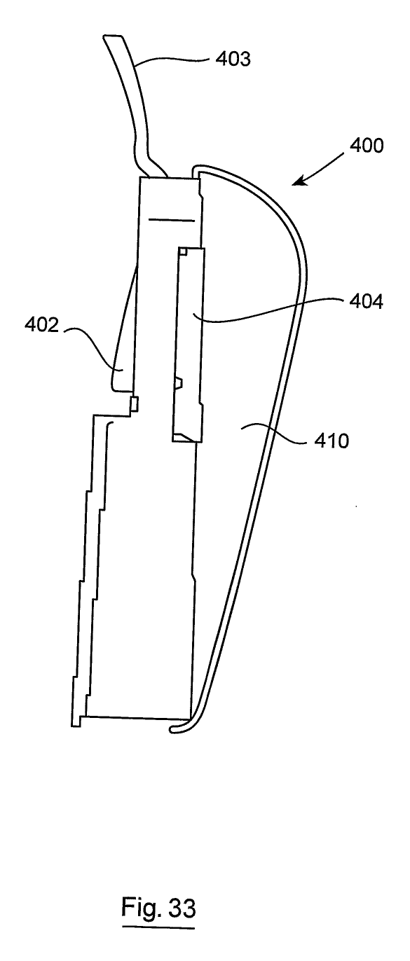

FIG. 33 is an end view of the holding device shown in FIGS. 31 and 32; and

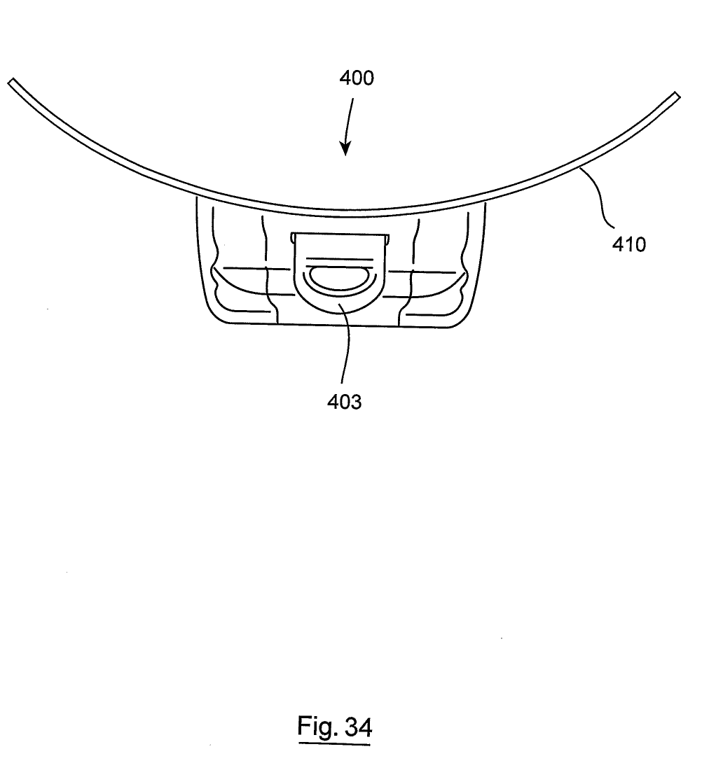

FIG. 34 is a plan view of the holding device shown in FIGS. 31-33.

The decorating system described herein makes the job of decorating both easier and safer. With the system, it is not necessary to climb ladders, steps, scaffolding and formers with only one hand whilst attempting to carry paint roller trays and paint pots, rollers, paint brushes, wallpaper brushes, and the like, in the other. The system also avoids the requirement to balance or temporarily fix onto these ladders and structures, the paint containers and accessories whilst decorating.

Rather, the system allows the various components to be easily and safely fitted to the user or directly to the workplace, leaving both hands free to ascend and descend access devices. The decorating medium receptacle improves accessibility to paint and makes it simple to regulate roller or brush loading. With the decorating medium receptacle and the decorating medium storage vessel, a decorator can rest without needing to worry about up-tipping a roller tray or decorating medium can. The decorating implement holder allows the decorator easy access to all their implements or tools at the workplace at all times. The tools (paint rollers, paint brushes, wall-paper tools, and the like) are safely and ergonomically stored on-board the various attachments.

A decorating medium receptacle 1 according to the present invention is shown in FIGS. 1, 3 to 5 and 7. A detachable platform 20 shown in FIGS. 2 to 4 and 6 to 7 is designed to insert into the receptacle, as shown in FIGS. 3, 4 and 7. FIGS. 3 to 5 and 7 show that the receptacle includes a side compartment 2 on each side suitable for receiving a paint brush 40. The platform accommodates a roller with a handle 41 and roller portion 42, with the handle being securable to the receptacle by means of a clip-on roller grip 3 (a stop means) shown in FIG. 4.

The receptacle is made of moulded plastic and is designed to hold a reasonable quantity of decorating medium 15 such as paint, wall-paper paste or other decorating liquids such as cleaners, strippers, and the like. The base 4 of the receptacle is rounded to facilitate ease of roller loading and to alleviate corners capable of trapping the chosen liquid. The receptacle is provided with two leveling feet 5 which allow the receptacle to stand upright and be self-supported for filling.

The receptacle has a brush scraper 6 at each front corner (for right hand and left hand use) to facilitate, for example, the normal action of drawing a paint brush across an edge to remove excess paint.

As shown in particular in FIGS. 5B to 5D, below the right hand front corner, there is a cut away section with a pouring lip 7 to allow for emptying.

A metal and plastic carrying handle 8 is mounted on two fulcrum sections moulded into each side of the receptacle.

A clip-on roller grip (or stop means) 3 is provided. By rotating the grip to the rear, it is possible to lock-off the paint roller when the roller is left in the docking position. This enables the user to move around easily without the roller falling into the paint vessel or falling forward to the front of the vessel.

At each end of the receptacle there are side containers which are self-draining into the container via cavities provided in the moulding.

The rear wall of the receptacle is raised to form a guard 9 which has two “key-hole” apertures 10 that mate with two mounting buttons 101 fitted to the holding device 100 (see FIGS. 21 and 22 below). The rear wall also has two raised channels (not shown) to assist the user in guiding the receptacle onto the mounting buttons of the holding device when it is fitted to the user's waist.

The rear upper lip of the receptacle is slightly relieved to form a mounting rim for the platform (see FIGS. 7A and 7B). The rear upper lip of the receptacle is fitted with a locking stop which, when fitted to the holding device, ensures that the receptacle cannot be accidentally knocked off the holding device whilst maneuvering.

The receptacle is balanced when filled. It is aesthetically pleasing and ergonomically designed to facilitate ease of use.

The receptacle can be mounted (or clipped) directly on to the holding device and can be adapted for a number of uses by insertion of a number of bespoke attachments. Such attachments include but are not limited to the roller platform, a window cleaning kit, or a household polishing kit.

The receptacle in one embodiment measures approximately 34 cm overall in length by 23 cm high which includes the side compartments (or paint brush holders) at each end, and the rear decorating medium guard encompassing a mounting system for a holding device as described below. The container part of the receptacle for holding decorating medium such as paint is about 27 cm long by 18 cm wide by 15 cm deep. The side containers may be approximately 8 cm deep by 5 cm wide to accommodate perhaps a 40 mm and a 25 mm brush.

The roller platform is a moulded plastic item designed to sit in the receptacle by means of two locating folds 21 sitting over a relieved section of the paint guard of the receptacle. The main purpose of roller platform is to provide the user with an effortless method of distributing paint onto, for example, a standard 20 cm paint roller, using a vertical motion as opposed to the normal horizontal technique. It is just as effective for any roller material or smaller rollers.

The roller platform is contained within the receptacle, thereby eliminating splashing and drippage. The platform is vertically inclined to reduce accumulation of paint. The platform is curved at its base 22 to act as a support for the paint roller when not in use. This is further enhanced with a tubular stop 23 to ensure the roller remains in this curved housing. The curved base has drain holes 24 to allow excess paint to fall into the receptacle.

The platform has eight moulded ribs or tracks 25 which serve to regulate the paint loading of the roller. At the rear of the platform, there are supports to maintain the correct angle of use.

The platform in one embodiment is about 23 cm wide by 20 cm high.

A decorating medium storage vessel 50 is shown in FIGS. 8 to 14. The storage vessel is made of moulded plastic and is designed to clip directly onto a holding device in the same way as the decorating medium receptacle. The storage vessel can be attached to the holding device to allow a user to access their work with both hands free.

The storage vessel is designed in one embodiment to carry a decorating medium pot 51 (for example, a paint tin) and a paint brush 40 or the like. This vessel can accommodate a 0.5 litre or a 1 litre standard tin of paint or alternatively serve as a paint container (or kettle) on its own. The base of the storage vessel is moulded to accommodate both sizes of paint tin in such a way as to prevent movement.

At each side of the vessel's moulded lip, a brush support 52 is mounted, to work in conjunction with a drop down brush scraper 53. The brush supports (for right hand and left hand use) are lined with a flexible band which restricts the brush from sliding or falling off its holder.

Attached to a rear back-plate 54 of the vessel, by means of a moulded clip-on hinge, the drop-down paint scraper also serves as the centre brush support. Once again a flexible insert is provided to restrict the brush movement. When placed over the lip of the vessel, the scraper clips over the front edge of the vessel which has been provided with a locking lip.

At each side of the scraper, the moulding of the vessel provides a tapered edge to remove excess paint from the brush. This alleviates having to rely on a paint tin, which is the usual method, normally causing paint to run down the side of the tin. In the present embodiment, excess paint simply drips into the centre of the tin avoiding the sides totally.

The paint scraper, when not in use, is held back vertically by means of a moulded button and mating fixing hole. Alternatively, the scraper can be unclipped completely from the hinge.

The supporting back-plate of the vessel is designed to fit the holding device and is drilled in two places to form “key-hole” apertures 55 to mate with two mounting buttons 101 fitted to the holding device 100 (see below).

The top lip of the vessel is fitted with a locking stop which, when fitted to the holding device, ensures that the device cannot be accidentally knocked off the holding device whilst maneuvering.

In one example, the vessel measures approximately 16 cm wide by 20 cm high, including the supporting back-plate.

A wallpaper implement holder 60 of the invention is shown in FIGS. 15 to 20. The implement holder is a plastic tool tray designed to hold a number of decorating implements (or tools) associated with wallpaper hanging.

The implement holder has an easy-clean body 61 fitted with a drop-down carrying handle 62. The body has a moulded guide channel at each interior side to accommodate two slide-in tool holders or compartment parts, for example a small tool pocket 63 (a first compartment part) and a brush pouch 64 (a second compartment part). The small tool pocket is designed to hold five decorators tools, such as edge roller, cutting knife, scraper, small paste brush and scissors. The scissors, for example, can be fitted into either end of the device for left hand and right hand use. The small tool pocket can be removed from the implement holder by means of a handle-shaped cut-out.

The brush pouch, when inserted into the front of the implement holder, is designed to accommodate a wallpaper smoothing brush together with a number of other features. Insertion of the brush pouch alongside the small tool pocket creates a gap (for example, of approximately 15 mm) suitable for storing a smoothing and cutting edge tool. The front of the brush pouch has a cut-out capable of holding a small removable plastic glue container. Adjacent to this is a tape measure holder.

A pencil holder 66 may also be designed into the implement holder.

The metal and plastic carrying handle is mounted on two fulcrum sections moulded into each side of the implement holder.

The implement holder is designed to clip on to the holding device in the same way as the receptacle and the vessel. A back plate of the implement holder is drilled in two places to form “key-hole” apertures 67 to mate with two mounting buttons 101 fitted to the holding device 100. At the rear of the holding device, there are two raised channels to assist the user in guiding the implement holder onto the mounting buttons of the holding device when it is fitted to the waist.

A top lip of the implement holder is fitted with a locking stop which, when fitted to the holding device, ensures that the device cannot be accidentally knocked off the holding device whilst maneuvering.

The implement holder is designed to be balanced when filled.

In one example, the implement holder measures approximately 28 cm overall in length by 19 cm wide by 19 cm deep.

The holding device 100 is illustrated in FIGS. 21 and 22. The holding device is a rigid moulded plastic support, designed to accommodate a webbing belt 102, for example a 35 mm belt, fitted with a plastic quick-release, self-locking buckle.

The holding device with belt can either be fitted to the waist of the user (left or right handed) or attached directly to a ladder, steps, platform, and the like.

All the components of the decorating system are designed to easily attach to the holding device by means of two support buttons 101 which mate in the “key-hole” apertures provided on these components, thus allowing the user access their work with both hands free.

A sprung lock 103 is provided on the holding device to ensure the attachments cannot be accidentally unclipped.

The belt loops 104 moulded into the rear of the holding device are arranged in such a way as to keep the support flat against the person.

In summary, the decorating system makes the job of decorating both easier and safer. The principle of having the “tools of the job” safely attached to the person or directly attached at the workplace by means of a simple but effective clip-on system is a preferable practice than trying to carry a number of items whilst attempting to access the workplace.

The components of the system could also be used for a number of other tasks, such as varnishing and wood treatment, paint stripping, or even window cleaning. The components of the system are preferable strong enough to support the tools required for specific tasks.

There are numerous options for other inserts for the components of the system to make DIY and light professional work safer for the users. For example, other inserts and attachments envisaged for the decorating medium receptacle and/or the implement holder are a small tools insert for screw drivers, pliers, hammers, and the like, or a household cleaning and polishing insert. An attachment for a battery operated drill and screwdriver could be made to fit directly onto the holding device. Additionally or alternatively, an attachment allowing hammer and fixings could be made to fit directly onto the holding device.

A second embodiment of a decorating medium receptacle 201 according to the present invention is shown in FIGS. 23-26. The decorating medium receptacle here comprises an integral platform 220 for receiving and holding a roller (not shown). The platform is vertically inclined to reduce accumulation of paint. The platform has moulded ribs or tracks 225 which serve to regulate the paint loading of the roller. The platform is curved at its base 222 to act as a support for the paint roller when not in use. The curved base has drain slots 224 (formed by fingers at the base of the platform) to allow excess paint to fall into the receptacle.

The receptacle further comprises a carrying handle 208 with ends insertable into two fulcrum sections moulded in each side of the receptacle. The receptacle excludes a side compartment.

The receptacle is one-piece plastic moulded and approximately 12.7 cm (about 5 inches) in width across its open end (i.e. between the handle fulcrum sections).

The receptacle can be mounted (or clipped) directly on to a holding device (for example as shown in FIGS. 31-34 described below) via a dovetail projection 230 at the rear of the receptacle.

A third embodiment of a decorating medium receptacle 301 according to the present invention is shown in FIGS. 27-30. Here, the platform 320 for receiving and holding a roller (not shown) is releasable attachable to the receptacle. The receptacle further comprises a carrying handle 308 with ends insertable into two fulcrum sections moulded in each side of the receptacle. Each side of the carrying handle facing into the receptacle now includes a tapered area which can be used as a brush scrape 310. The receptacle includes on each side a side compartment 302 suitable for receiving a paint brush or the like (not shown).

The receptacle is approximately 22.86 cm (about 9 inches) in width across its open end (i.e. between the handle fulcrum sections).

The receptacle can be mounted (or clipped) directly on to a holding device (for example as shown in FIGS. 31-34 described below) via a dovetail projection 330 at the rear of the receptacle.

As with the first receptacle described above, the receptacles 201, 301 are designed to hold decorating medium such as paint, wall-paper paste or other decorating liquids such as cleaners, strippers, and the like. The bases 204, 304 of the receptacles are rounded to facilitate ease of roller loading and to alleviate corners capable of trapping the chosen liquid. Each receptacle is provided with a leveling platform 205, 305 which allows the receptacles to stand upright and be self-supported for filling.

Components of the decorating system of the present invention, for example the receptacle shown in FIGS. 24-30, may be adapted to be attachable to a second embodiment of a holding device 400 shown in FIGS. 31-34. This holding device comprises a curved support 410 from which projects an attachment site 401 to receive a corresponding dovetail projection (for example, dovetail projections 230 and 330 shown in FIGS. 25 and 29). The holding device further comprises a sprung lock 402 which locks the dovetail projection in place when inserted into the attachment site. The sprung lock can be released by means of a lever 403 which protrudes from the holding device and which can be easily and single-handedly operated (for example, using a thumb). This allows a user to keep one hand available for safety or other reasons, for example to keep one hand on a ladder or steps while attaching or removing a component of the decorating system onto the holding device.

The curved support 410 is designed to sit comfortably against a user, for example against the user's hips. The holding device is held in position against the user by means of a belt (not shown) which can be threaded through belt aperture 404.

Although the present invention has been described with reference to preferred or exemplary embodiments, those skilled in the art will recognize that various modifications and variations to the same can be accomplished without departing from the spirit and scope of the present invention and that such modifications are clearly contemplated herein. No limitation with respect to the specific embodiments disclosed herein and set forth in the appended claims is intended nor should any be inferred.

All documents cited herein are incorporated by reference in their entirety.

1. A decorating system comprising:
(a) a decorating medium receptacle for use in an upright position with a roller-type applicator, in which the receptacle has walls extending upwardly from a base forming a container which receives decorating medium, and a removable or integral rolling platform positioned within the receptacle at an angle to a wall, for example a back wall, with a distal part of the platform located towards the base of the receptacle and forming a roller-type applicator support means; and optionally further comprising
(b) a decorating medium storage vessel; and/or
(c) a decorating implement holder.

2. The system of claim 1, in which the distal part of the platform is curved to form the roller-type applicator support means.

3. The system of claim 1, in which the distal part of the platform has a stop means to provide support to the roller-type applicator.

4. The system of claim 1, in which the distal part of the platform has an aperture, for example one or more perforations, to allow drainage of decorating medium from the platform and/or roller-type applicator into the container.

5. The system of claim 1, in which the platform comprises a transverse rib to assist loading of decorating medium onto a roller-type applicator.

6. The system of claim 1, in which the platform is positioned within the receptacle at an angle from a wall, for example from the back wall, by a positioning means optionally integral with the platform.

7. The system of claim 1, in which the platform when removable has a locating means at its proximal end for attaching to a wall.

8. The system of claim 1, in which the receptacle further comprises a compartment for holding a decorating implement.

9. The system of claim 8, in which the compartment is in fluid communication with the receptacle, for example by means of a perforated or open base and/or a side-wall of the compartment.

10. The system of claim 8 in which the receptacle comprises a compartment located on each of two opposite side-walls of the receptacle.

11. The system of claim 1, in which a promixal end of a wall away from the base of the receptacle comprises a scraping edge.

12. The system of claim 1, in which an upper rim of a wall or junction between two walls of the receptacle comprises a pouring lip.

13. The system of claim 1, in which the receptacle comprises a securing means for securing a handle of the roller-type applicator when not in use and/or a handle.

14. (canceled)

15. The system of claim 1, in which the vessel comprises an open end formed by an upper rim of side walls extending upwardly from a base, in which the vessel is suitable for holding a decorating medium and/or a decorating medium pot.

16. The system of claim 15, in which the base of the vessel is stepped to provide a snug fit with one of two or more differently-sized decorating medium pots.

17. The system of claim 15, in which the vessel comprises a device which is positionable across the open end and which allows for removal of excess decorating medium from a decorating implement.

18. The system of claim 17, in which the device comprises a tapered edge or provides a resting surface for the decorating implement.

19. (canceled)

20. The system of claim 17, in which the device has an arm hinged to a side of the vessel to allow the device to be positioned across and/or to be raised from the open end of the vessel.

21. The system of claim 15, in which the vessel comprises a decorating implement support structure mounted onto the upper rim or in which the vessel has a handle.

22. (canceled)

23. The system of claim 1, in which the decorating implement holder comprises multiple compartments which accommodate decorating implements and optionally decorating medium and optionally further comprises a handle.

24. (canceled)

25. The system of claim 1, comprising a holding device onto which a mounting means located on the receptacle and/or the vessel and/or the decorating implement holder can be detachably mounted.

26. The system of claim 25, in which the holding device comprises a holster.

27. The system of claim 26, in which the holster is attachable to a belt, a ladder, steps, platform or shelf.

28. The system of claim 25, in which the holding device comprises part of a ladder, steps, platform or shelf.

29. The system of claim 25, in which the holding device provides a storage means for the receptacle and/or the vessel and/or the decorating implement holder.

30. The system of claim 25, in which the mounting means comprises an attachment means for securing the receptacle and/or the vessel and/or the decorating implement holder to a complementary attachment means on the holding device.

31. (canceled)

32. The system of claim 1, in which the decorating implement is one or more of the group consisting of: a paint brush, an edge roller, a knife, a scraper, a paste brush, scissors, a pencil, and a tape measure.

33. (canceled)

34. A decorating medium receptacle as defined in claim 1.

35. (canceled)

36. A decorating medium storage vessel as defined in claim 1.

37. (canceled)

38. A decorating implement holder as defined in claim 1.

39. (canceled)

40. A holding device as defined in claim 25.

41. (canceled)
